(19) United States
(12) Patent Application Publication
(10) Pub. No.: US 2010/0162286 A1
(43) Pub. Date: Jun. 24, 2010

(54) SYSTEMS AND METHODS FOR ANALYZING TRENDS IN VIDEO CONSUMPTION BASED ON EMBEDDED VIDEO METADATA

(75) Inventor: Matthew G. Berry, Raleigh, NC (US)

Correspondence Address: Seyfarth Shaw LLP, One Peachtree Pointe, 1545 Peachtree Street,N.E. Suite 700, Atlanta, GA, 30309, US

(73) Assignee: DIGITALSMITHS CORPORATION, Morrisville, NC (US)

(21) Appl. No.: 12/624,987

(22) Filed: Nov. 24, 2009

Related U.S. Application Data
(60) Provisional application No. 61/117,454, filed on Nov. 24, 2008.

(51) Int. Cl. H04H 60/32

(52) U.S. Cl. 725/14

(57) ABSTRACT

Systems and methods are described for analyzing video content in conjunction with historical video consumption data, and identifying and generating relationships, rules, and correlations between the video content and viewer behavior. According to one aspect, a system receives video consumption data associated with one or more output states for one or more videos. The output states generally comprise tracked and recorded viewer behaviors during videos such as pausing, rewinding, fast-forwarding, clicking on an advertisement (for Internet videos), and other similar actions. Next, the system receives metadata associated with the content of one or more videos. The metadata is associated with video content such as actors, places, objects, dialogue, etc. The system then analyzes the received video consumption data and metadata via a multivariate analysis engine to generate an output analysis of the data. The output may be a scatter plot, chart, list, or other similar type of output that is used to identify patterns associated with the metadata and the one or more output states. Finally, the system generates one or more rules incorporating the identified patterns, wherein the one or more rules define relationships between the video content (i.e. metadata) and viewer behavior (i.e. output states).

### CROSS REFERENCE TO RELATED APPLICATION

This application claims the benefit under 35 U.S.C. §119(e) of U.S. provisional patent application No. 61/117,454, entitled “SYSTEMS AND METHODS FOR ANALYZING TRENDS IN VIDEO CONSUMPTION BASED ON EMBEDDED VIDEO METADATA,” filed Nov. 24, 2008, which is incorporated herein by reference in its entirety as if set forth in full herein.

### TECHNICAL FIELD

The present systems and methods relate generally to analyzing trends and patterns in video consumption, and more particularly to identifying trends in video viewer activity as a function of embedded video metadata for purposes of optimizing content associated with video media.

### BACKGROUND

Information relating to viewer interaction with video media, whether that media is Internet videos, DVDs, television programs, etc., is invaluable for a variety of purposes, including advertising, editing video content, and the like. Current systems enable tracking of viewer behavior during videos, such as whether a viewer rewinds a video to a certain point to watch part of the video again, or if a viewer pauses the video at a particular time, etc. These behaviors are often tracked for Internet videos by simply recording user interaction with a media player, but may also be tracked and recorded on home television sets via a set-top-box attached to the television or through a digital cable system. This viewer behavior data (generally referred to as “viewing metrics” or “video consumption data”) provides information that enables content associated with videos to be edited or adapted to meet a desired objective, such as by targeting advertising to frequently-watched scenes, or editing a video to remove portions that are regularly ignored.

Typically, video consumption data comprises common “output states” for videos, which describe viewer actions associated with the video, such as i) fast-forwarding a video, ii) rewinding a video, iii) pausing a video, iv) closing a video player, v) navigating to a new video program (i.e. changing the channel or selecting new program in a video player), vi) engaging with an advertisement (i.e. clicking on an Internet advertisement or somehow otherwise interacting with an advertisement), and other similar actions. These output states are tracked and recorded for a wide range of videos across many viewers over time to develop trends in viewer behavior for each video. For example, a trend may emerge that indicates that 40% of viewers rewind and watch a certain portion of a particular video more than once. The output states are relatively easy to track for Internet videos by simply monitoring user interaction with a media player. Also, with the advent of digital video recording, more viewing metric data is becoming available for television use.

However, these viewing metrics only tell part of the story. They do not explain why viewers engage in certain behaviors while watching videos. Thus, while video consumption data may he helpful for one particular video, that same information generally cannot be readily applied to other videos—even if those videos are related to the given video (i.e. same actors, similar subject matter, etc.)—because there is no direct link between the viewer behavior and the content of the video. At best, viewing metrics can be compared to the corresponding video content on a video-by-video basis, and a guess can be made as to why certain viewer behavior occurs. For example, it may he assumed that viewers fast-forward through certain scenes because the scenes are boring, depressing, or just too long. Or, it may be assumed that viewers rewind and watch a certain portion of a video repeatedly because a popular actor or actress is in that portion of the video. However, the assumptions made about video content to explain viewer behavior are merely best guesses—they are imprecise, often time consuming to generate, and frequently inaccurate. Therefore, because it is difficult to link viewer behavior with common video concepts (such as a specific actor, setting, dialogue, etc.), viewing metrics are typically only helpful on a per-video basis. If a new video is introduced, targeted advertisements or other video content generally cannot be applied to the video until viewing metrics are obtained, overtime, for the specific video.

Further, many viewer behaviors may be triggered by a combination of several video content elements happening in a video at once, and thus no direct correlation can be drawn between one particular content element and a resulting viewer behavior. For instance, viewers may consistently choose to stop watching a particular video at a certain point in the video not because of any one element, but because a combination of many elements may make the video no longer appealing. As an example, a certain actor may be very popular in one video, causing a high rate of viewer interest in the video. However, the same actor in another video, based on the actor's character, a particular setting, and the overall subject matter of the video, may cause the video (or a scene in the video) to be highly unpopular, causing many viewers to exit the video. Accordingly, analysis of the second video may reveal that it was the combination of the character, setting, and subject matter of the video that caused viewers to exit the video. However, because traditional viewing metrics do not link content of videos to viewer behavior, the particular combination of content attributes that made the scene within the video unpopular may never be discovered.

Additionally, for advertising purposes, pure viewing metrics alone are often insufficient to optimize user interaction with or attention to advertisements. For example, Internet videos may display banner or pop-up advertisements while the videos are playing. An advertiser may elect to display such advertisements during the most-watched portions of a video (as indicated by video consumption data) because the advertiser believes the viewer is paying a great deal of attention to this portion of video, and thus will be likely to see the advertisement. However, it may actually be the case that because the viewer is highly-interested in the content of the video itself, the viewer pays little or no attention to the displayed advertisement. Thus, while simply tracking viewer behavioral trends may provide some helpful information to an advertiser or video editor, the reasons why viewers engage in certain behaviors, such as why a viewer clicks on an advertisement during a video, or what it is about the video that makes it popular, could be far more important.

If it were available, information relating to the causes behind viewer behavior could he applied across a wide range of videos and media, including new videos in which no viewing metrics are available. If correlations could be drawn between certain aspects or attributes of videos and corresponding viewer behavior, then advertisers, video editors, and other content providers could tailor future videos and advertisements accordingly.

Therefore, there is a long-felt but unresolved need for systems and/or methods that compare the behavior of viewers of video media with the associated content of the video media to generate and identify correlations, rules, and trends between specific content elements of the media and corresponding viewer behavior.

### BRIEF SUMMARY OF THE DISCLOSURE

Briefly described, and according to one embodiment, the present disclosure is directed to systems and methods for analyzing video content in conjunction with historical video consumption data, and identifying and generating relationships, rules, and correlations between the video content and viewer behavior. According to one aspect, a system receives video consumption data associated with one or more output states for one or more videos. The output states generally comprise tracked and recorded viewer behaviors during videos such as pausing, rewinding, fast-forwarding, clicking on an advertisement (for Internet videos), and other similar actions. Next, the system receives metadata associated with the content of one or more videos. The metadata is associated with video content such as actors, places, objects, dialogue, etc. The system then analyzes the received video consumption data and metadata via a multivariate analysis engine to generate an output analysis of the data. The output may be a scatter plot, chart, list, or other similar type of output that is used to identify patterns associated with the metadata and the one or more output states. Finally, the system generates one or more rules incorporating the identified patterns, wherein the one or more rules define relationships between the video content (i.e. metadata) and viewer behavior (i.e. output states).

### BRIEF DESCRIPTION OF THE DRAWINGS

The accompanying drawings illustrate one or more embodiments of the disclosure and, together with the written description, serve to explain the principles of the disclosure. Wherever possible, the same reference numbers are used throughout the drawings to refer to the same or like elements of an embodiment, and wherein:

FIG. 1 illustrates one embodiment of the system architecture for a system for analyzing and identifying trends between video content and viewer behavior.

FIG. 2 is a flowchart showing the overall process steps involved in analyzing metadata and video consumption data to identify trends in viewer behavior in response to video content according to an embodiment of the present system.

FIG. 3 illustrates an exemplary K-space (where K=3) in which a plurality of data points have been plotted.

FIG. 4 shows a sample output from the multivariate analysis engine according to an embodiment of the present system.

FIG. 5 is a loading plot of exemplary metadata variables contributing to one or more output states for a video or videos.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is hereby intended; any alterations and further modifications of the described or illustrated embodiments, and any further applications of the principles of the disclosure as illustrated herein are contemplated as would normally occur to one skilled in the art to which the disclosure relates.

Aspects of the present disclosure generally relate to systems and methods for analyzing video content in conjunction with historical video consumption data, and identifying and generating relationships, rules, and correlations between the video content and viewer behavior. In one embodiment, the present system compares metadata associated with video content for a plurality of videos with various output state data of those videos via a multivariate analysis (MVA) engine. The MVA engine analyzes the metadata in conjunction with the output states to identify patterns between the metadata and output states. Once patterns are identified, rules and correlations can be generated based on predefined parameters that link specific video content to specific viewer behaviors for subsequent advertising, content editing, and other similar purposes.

Overall, one purpose of the present system is to develop explicit correlations between metadata elements or combinations of metadata elements (linked to specific video content) and specific viewer behaviors (in the form of output states). These correlations may be used to determine why viewers engage in certain behaviors during videos, such that those behaviors can be utilized for a variety of purposes. For example, if a direct correlation can be drawn between a specific metadata element or group of elements and a high percentage of viewers interacting with an advertisement, then similar advertisements can he incorporated into videos at specific time-codes when the metadata element(s) are present. The benefits and uses of specific correlations between content metadata and viewer behaviors will be appreciated by those of ordinary skill in the art, and further described herein.

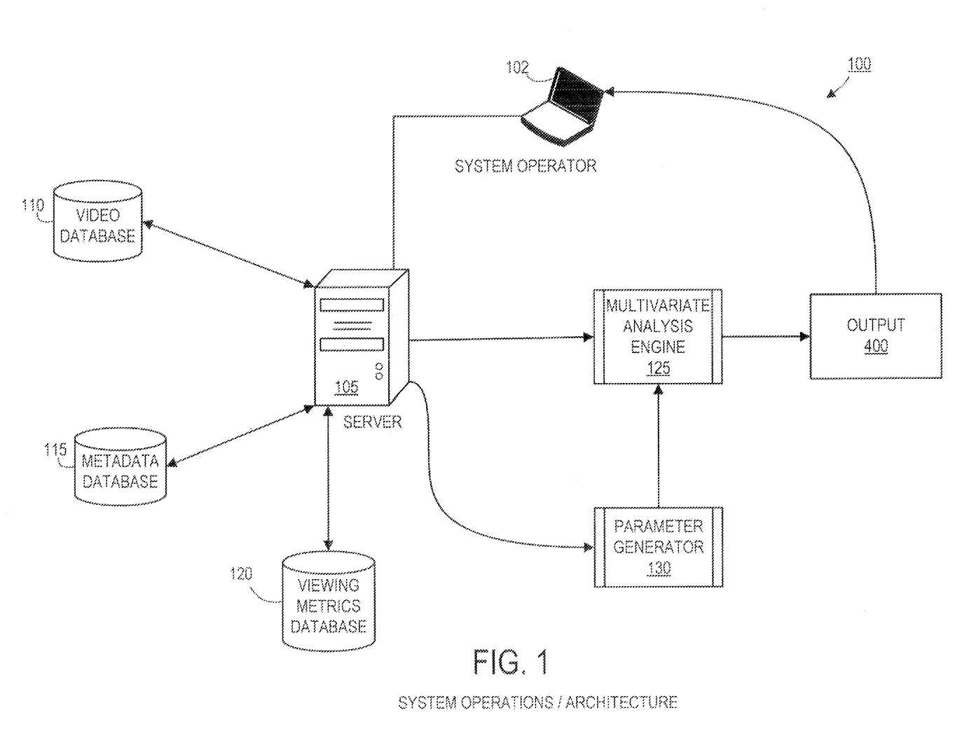

Referring now to the drawings, FIG. 1 illustrates one embodiment of the system architecture for a system 100 for analyzing and identifying trends between video content and viewer behavior. In the embodiment shown, the system 100 includes a server 105, a video database 110, a metadata database 115, and a viewing metrics database 120. The system 100 further includes a multivariate analysis (MVA) engine 125 that receives limiting parameters from a parameter generator 130, and generates an output 400. Although the embodiment of system 100 shown in FIG. 1 includes only one of each of these components, one having ordinary skill in the art will understand that further embodiments may include a plurality of each or any of these components.

In the embodiment shown, the server 105 provides processing functionality for the system 100, including receiving instructions from an operator 102, retrieving videos and viewing metric data, extracting embedded metadata from videos (or obtaining metadata otherwise associated with the videos), providing information to the MVA engine 125, and a host of other operations that will be or become apparent to one of ordinary skill in the art. Additionally, while only one server 105 is shown, it will be understood that a plurality of servers may be incorporated within embodiments of a computerized system 100. It will also be understood that such server(s) 105 include suitable hardware and software components for performing the functions and/or steps and taking the actions described herein.

In one embodiment, the server 105 interacts with the video database 110, which stores a plurality of videos for use within the system 100. The stored videos may be any multimedia content, such as movies, television programs, music videos, short clips, commercials, internet-created or personal videos, and other similar types of video media or multimedia. In some embodiments, these stored videos are embedded with metadata related to elements or content of the videos, such as actors or characters within the videos, products in the videos, places and settings shown or described in the videos, subject matter, dialogue, audio, titles, and other similar video attributes. In other embodiments, metadata is previously associated with the respective video but not embedded in the video per se. In other embodiments, some or all of the videos in the video database 110 do not previously have metadata embedded or associated with the video, and thus the system 100 must assign metadata attributes to the content of the videos (described in greater detail below).

Within embodiments of the present system 100, the server 105 extracts or obtains metadata from the videos and stores the metadata in the metadata database 115. In one embodiment, the metadata is further stored in metadata files that are associated with each specific video. Thus, the metadata database 115 includes one or more separate metadata files for each video in the video database 110, such that each metadata file or files includes all of the metadata for its respective video. Generally, the metadata includes identifiers or tags that provide descriptions and/or identification means for each item of metadata. For example, an identifier for metadata signifying a particular actor could be the actor's name. The identifiers or tags may describe a basic understanding or provide a detailed description of the associated video. The metadata identifiers enable the metadata to be easily located and utilized within the system 100.

Additionally, in a preferred embodiment, the metadata is time-coded, such that some or all of each item of metadata is associated with a time-code or range of time-codes within a given video. For example, an item of metadata for a certain actor within a video may indicate that the actor is on screen in the video from the 2 minute, 36 second mark of the video to the 4 minute, 41 second mark, and then does not appear in the video again. Another item of metadata may indicate that an object within a video, such as a car, is seen multiple times throughout the video, and at varying time-codes. On the other hand, some metadata may be associated with the entire video, such as metadata associated with the overall subject matter of a video, or with the title of a video, in which case it would not be tied to a time code. In one embodiment, the video consumption data is similarly time-coded to provide a baseline for comparison between the metadata and video consumption data. As will be appreciated, other embodiments of the system 100 rely on metadata and video consumption data that is not time-coded.

As mentioned, in one embodiment, some or all of the videos in the video database 110 arc not embedded with metadata. For these videos, the system 100 must associate metadata with the videos that require analyzation. Recently-developed technologies utilize facial recognition technology, textual analyzers, sound and pattern recognition technology, and other similar mechanisms to identify components within a video, and then associate time-coded metadata attributes automatically with those identified components. Metadata may also be associated with videos manually by viewing videos and associating metadata with items recognized by the viewer. One exemplary method for associating metadata with videos is described in U.S. Patent Publication No. 2004/0237101 to Davis et al., entitled “Interactive Promotional Content Management System and Article of Manufacture Thereof,” which is incorporated herein by reference in its entirety and made a part hereof. Once metadata has been associated with content components of a video, it may then be extracted (if necessary) and stored in the metadata database 115 for further use within the system 100.

Still referring to FIG. 1, the system 100 further includes a viewing metrics database 120 for storing video consumption data. As mentioned, video consumption data (or viewing metrics) is data related to viewer behavior in the form of various “output states,” which describe viewer interactions with a video, such as fast-forwarding, rewinding, pausing, playing, exiting the video, interacting with an advertisement, changing the channel, etc. As will be understood, virtually any user behavior may be tracked, and video consumption data is not limited to the specific output states mentioned. In one embodiment, the video consumption data may be obtained from a third-party vendor, such as Omniture, Inc., having a corporate headquarters at 550 East Timpanogos Circle, Orem, Utah 84097. Typically, viewer consumption data is collected for a wide-range of videos over time and amongst a wide-range of viewers to provide in-depth and statistically viable data.

Further, in one embodiment, viewing metrics may also include viewer demographic information indicating the types of viewer behaviors that are more common in certain viewer groups. For example, viewer demographic information may indicate that males are more likely to interact with sports advertisements than females, etc. This information may be obtained by tracking user-entered profiles, recently-viewed webpages, IP addresses, and other similar viewer indicia. Thus, this viewer demographic information may be used in conjunction with output state information to provide highly-specialized or tailored correlations between video content and viewer behavior.

Also connected to the server 105 within the computerized system 100 is a multivariate analysis (MVA) engine 125 for analyzing video consumption data in conjunction with content metadata to identify patterns or trends between the consumption data and the metadata. Multivariate analysis describes the observation and analysis of more than one variable at a time. Generally, MVA is used to perform studies across multiple dimensions while taking into account the effects of all variables on the responses of interest. In one embodiment, the MVA engine 125 comprises a proprietary software program. Such software programs may be written in and utilized via commercially available applications such as MATLAB®, available from The Mathworks, Inc., having a corporate headquarters at 3 Apple Drive, Natick, Mass. 01760-2098, and other similar applications or software programs.

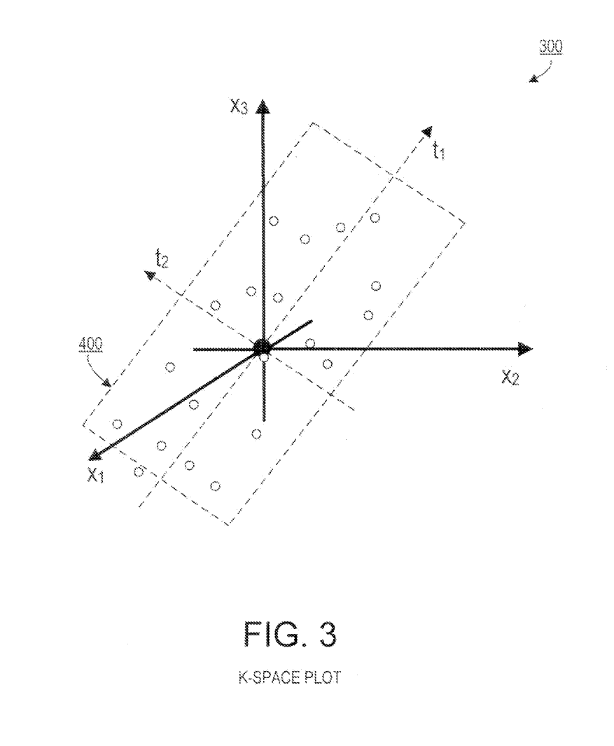

In a common multivariate analysis problem, a plurality of data points each having K variables is analyzed, where the number of variables K is only limited by the processing capabilities of the MVA engine 125. Typically, the plurality of data points is represented by a multidimensional array, wherein each row represents a given data point and each column represents one of the K variables. The data points in the multidimensional array arc plotted in a K-space, such that each of the K variables defines one orthogonal axis in a coordinate system. Although a K-space of greater than three dimensions is not easily visualized or conceptualized, it has a real existence analogous to that of the two- and three-dimensional spaces. For ease of visualization, FIG. 3 shows a K-space (where K=3) 300 in which a plurality of points have been plotted. To better interpret and analyze the plotted data, a two-dimensional window 400 may be projected into the K-space to provide an easily interpretable and viewable display (a process commonly referred to as “projection”). This window is analogous to the output 400 of the MVA engine 125 of the present system 100 and is used to identify patterns and generate rules based on groupings of data points (described in greater detail below). Further details regarding conventional multivariate analytics may he found in reference texts such as Kessler, Waltraud, Multivariate Datenanalyse für die Pharma-, Bio-, und Prozessanalyik, ISBN 3-527-31303-6, which is incorporated herein by reference in its entirety, as if set forth in full herein.

As described, conventional systems merely track video consumption data in response to viewer behavior. Essentially, these conventional viewing metrics systems merely record time-coded output states in response to viewer activity. Accordingly, these systems generally utilize a univariate approach, as the only input variable is a video. Embodiments of the present system 100, however, utilize a multivariate approach to analyze videos because a multiplicity of inputs are analyzed (i.e. the metadata). In fact, for videos with large amounts of metadata, the MVA engine 125 may analyze thousands of variables at once to produce a desired output. In one embodiment, data points in the present system 100 are represented as a multidimensional array (as described above), wherein K represents each element of metadata, and each data point (i.e. each row of the multidimensional array) represents each of the separate combinations of K variables within a given scene, video, or other selected data set that has contributed to produce one instance of a selected output state. In one embodiment, a plurality of output states may be analyzed to produce a plurality of data points, each including some combination of metadata attributes. As will be understood, the metadata attributes in the array may be represented as binary values (either 1 or 0, indicating a positive or negative presence of the attribute in the given data point), numerical values, percentages, or some other similar representative value.

In one embodiment, the MVA engine 125 compares the video metadata with corresponding video consumption data as a function of time-codes associated with each. As explained, each item of metadata preferably includes a time-code or range of time-codes indicating the point or points in a video in which its associated content occurs. Generally, video consumption data also includes such time-codes, indicating at which point or points during a video a certain viewer behavior (e.g., pause, rewind, stop, etc.) often occurred. Thus, the MVA engine 125 uses the time-codes as a baseline to compare the metadata and viewing metrics. For example, an element of video consumption data may indicate that 45% of viewers paused a particular video at the 5-minute mark of the video. The metadata tile for the particular video may indicate that a certain actor was on screen at the 5-minute mark. Thus, the MVA engine 125 may suggest some correlation between the actor and the video being paused. While this one example may not he adequately statistically significant to make a conclusion regarding the viewer action and the actor, other videos with the same actor can be analyzed to determine if a pattern develops between video pausing and the actor (again, based on similar time-codes).

During analysis by the MVA engine 125, certain parameters are applied to shape the output 400 and corresponding relationships drawn between the video content and viewer behavior. The predefined parameters are defined by the parameter generator 130 as entered into the system 100 by the operator 102. For example, a parameter may be defined that instructs the MVA engine 125 to identify any metadata that occurs within 5 seconds before a video is exited. Another parameter may instruct the MVA engine 125 to identify any metadata that is present when a viewer interacts with an advertisement. Further, because the MVA engine 125 generally analyzes historical average video consumption data, certain percentage parameters may be applied. For example, the system operator 102 may instruct the MVA engine 125 to assume that any user behavior that occurred more than 20% of the time is statistically significant—thus, if only 10% of viewers interacted with a particular advertisement during a video, then that interaction is ignored. As will be understood, these exemplary parameters are presented for illustrative purposes only, and a user or operator 102 of the system 100 may define whatever parameters he or she deems important or appropriate.

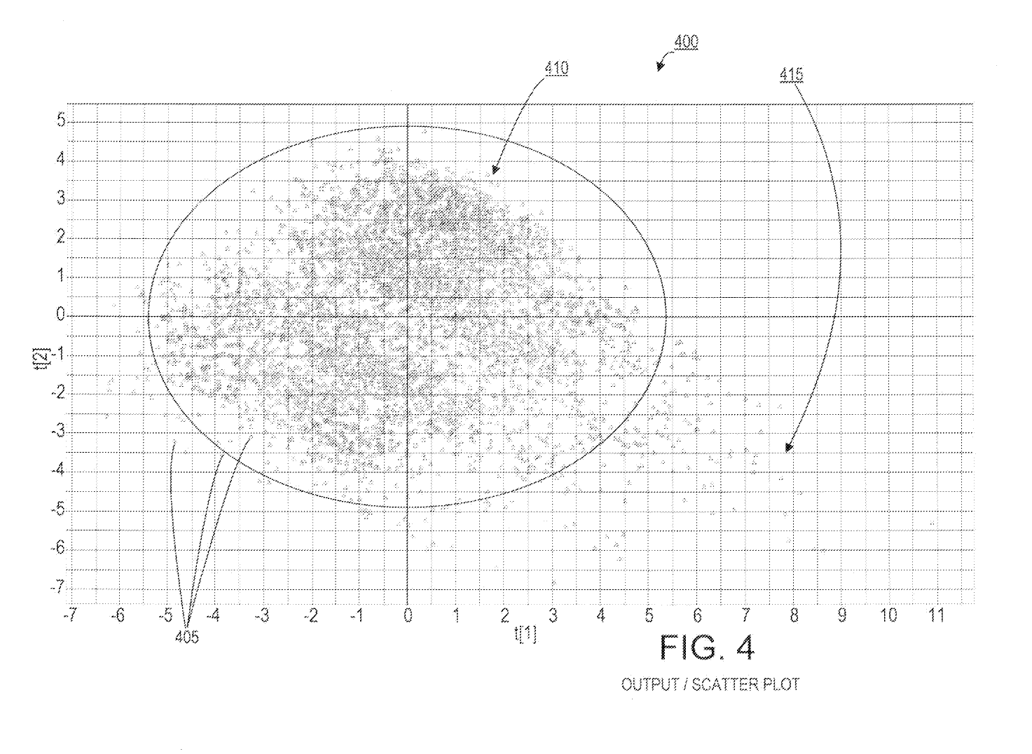

Still referring to FIG. 1, once all parameters, metadata, and video consumption data for a video or videos are received by the MVA engine 125, the MVA engine analyzes all of the input data and generates an output 400 of any identified patterns, relationships, trends, etc., between the metadata and output states. Generally, the output 400 comprises a two-dimensional window evidencing a scatter plot of data points taken from a comprehensive plot in K-space. As will be understood, however, the output 400 may comprise many forms, including charts or graphs comparing various output states to metadata for a given video, lists of percentages of viewers that engaged in a given behavior while a particular content element or combination of content elements was playing in a video, or some other similar type of output. An example output 400 is shown in FIG. 4 and described in greater detail hereinafter.

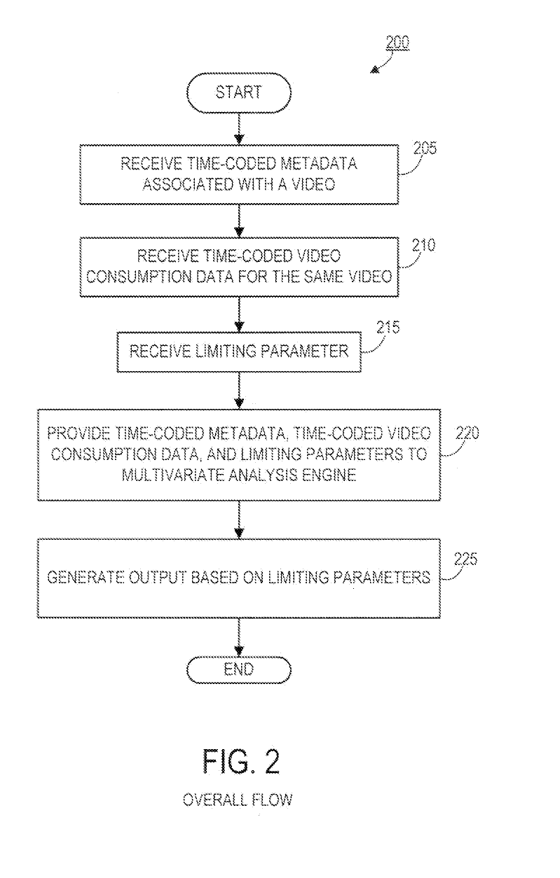

Referring first to FIG. 2, a flowchart is shown detailing the overall process steps 200 involved in analyzing metadata and video consumption data to identify trends in viewer behavior in response to video content according to an embodiment of the present system 100. Although the flowchart shown in FIG. 2 describes the process for analyzing a singular video, one having ordinary skill in the art will appreciate that the process may be extrapolated and/or repeated to analyze numerous videos. Initially, at step 205, the system 100 receives time-coded metadata associated with a video. As described, this time-coded metadata is associated with various content elements of the video, such as characters in the video, objects in the video, places described in the video, etc. At step 210, the system 100 receives time-coded video consumption data for the same video that is associated with the received metadata. Then, limiting parameters are received from the parameter generator 130, as dictated by the system operator 102 (step 215). Once received, the time-coded metadata, time-coded video consumption data, and limiting parameters are provided to the MVA engine 125, which then generates an output 400 based on the limiting parameters (steps 220 and 225). The data in the output 400 may then be used for a variety of purposes, as described herein.

FIG. 4 shows a sample output 400 (in graphical format) from the multivariate analysis engine according to an embodiment of the present system 100. The example output 400 shown is a scatter plot of multidimensional vectors (i.e. data points) 405 projected on a two-dimensional plane from within a K-space. The two-dimensional plane (or “window”) is oriented such that it provides a good overview of the data to enable more-simplified interpretation of the data. Generally, the MVA engine 125 automatically selects the orientation plane based on limiting parameters to create an efficient view of the data. However, as one having ordinary skill will understand, once the data is plotted in a K-space, the operator 102 may manipulate the data and/or window however he or she deems appropriate. By plotting the data in the output 400 in terms of a two-dimensional scatter plot, it becomes possible to view the relationships between the metadata and output states.

Additionally, in some embodiments, the MVA engine 125 incorporates principal component analysis (PCA) and/or factor analysis (FA) to discover sets of variables that form coherent subsets that are relatively independent of each other. The subsets are determined by locating and analyzing dense groupings of data points in an output 400. These subsets help determine which variables or groups of variables provide the largest contribution to various output states. For example, metadata relating to products in videos may cause higher percentages of viewer interaction with advertisements than metadata relating to characters in videos. Further, use of PCA and/or FA helps identify combinations of variables that alone have little or no impact on output states, but when taken in combination have a statistically significant correlation to one or more output states. In an alternative embodiment, partial least squares (PLS) regression analysis can be used instead of or in combination with PCA.

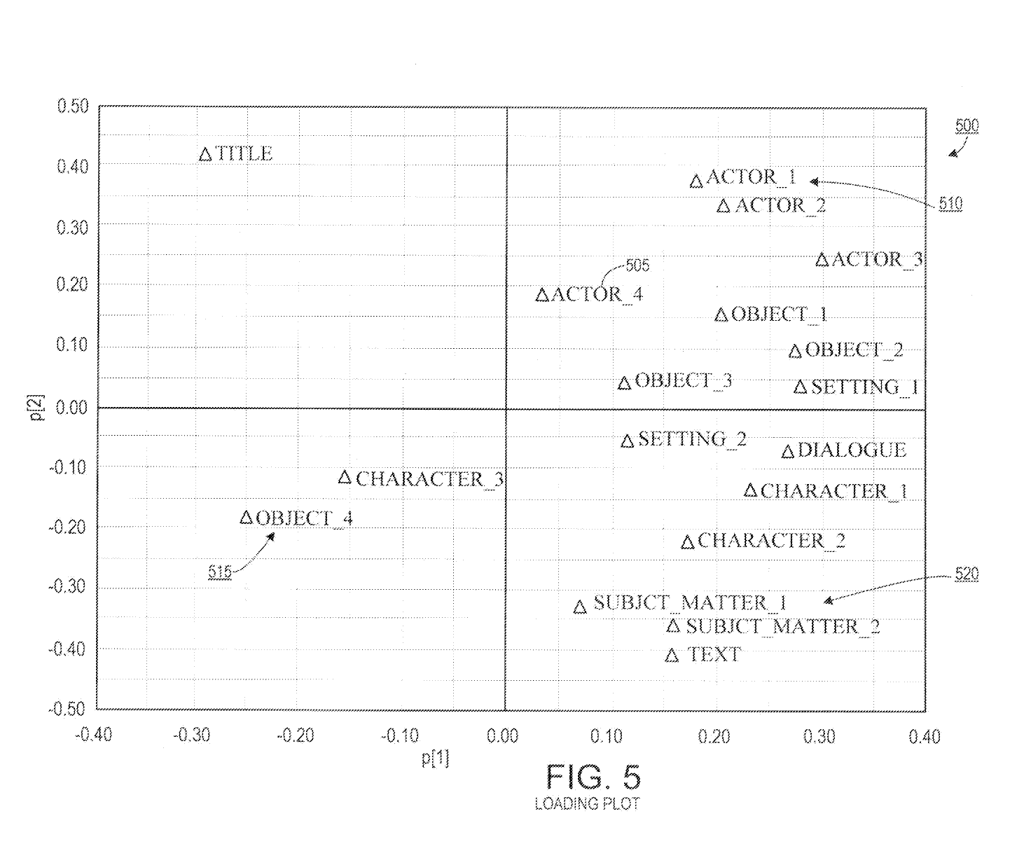

FIG. 4 illustrates that the plotted data may be grouped together into clusters of various densities for further analysis. For example, data group 410 comprises a high-density group, indicating some correlation between the variables (i.e. metadata) of the vectors in the group. On the other hand, group 415 includes very few data points, indicating little or no connection between the points in this plotted area. By drilling down into the projected window 400 and analyzing densely-grouped clusters of data points, it can he determined which data points share similar responses based on changes in variable values (described in greater detail below in conjunction with FIG. 5). These changes and responses help define which metadata elements or combinations of metadata elements affect a given output state.

As the plotted data in the output 400 is analyzed, it may be used to create rules or correlations between specific items of metadata and specific output states. For example, the plotted data in the output 400 may indicate some connection between a fast-forwarding output state and metadata associated with a particular subject matter. Thus, a rule may be generated that dictates that the given subject matter leads to fast-forwarding in some percentage of cases. This fast-forwarding may be an indication that viewers are uninterested in this type of subject matter. Regardless of the reason, however, it becomes understood that this type of subject matter is frequently ignored. Thus, video content for other videos, even videos with no video consumption data available, may be edited to avoid or remove that type of subject matter.

Further, it will be understood that rules may be generated that link not only singular items of metadata to output states, but combinations or groups of metadata to particular output states. As mentioned earlier, a given output state may be caused by a particular combination of video content elements, whereas any one of those elements, when taken alone, would not cause the noted output state. Conventional systems that merely track time-coded viewer behavior to videos are incapable of identifying such response-causing metadata combinations. Thus, the ability to generate rules based on multiple metadata variables via a multivariate and principal components approach makes aspects of the present system 100 particularly useful for targeting or editing video content in response to the generated rules.

In addition to a scatter-plot type of output, as shown in FIG. 4, in one embodiment, the MVA engine 125 may further analyze the plotted data to create a loading plot 500, as shown in FIG. 5. Generally, a loading plot demonstrates which variables 505 are influential to each other, and to a given output state. Variables that contribute similar information (i.e. are positively correlated) are grouped together. For example, in the loading plot 500 shown in FIG. 5, groups of variables 510, 520 indicate that there is some correlation between the variables 505 in those groups. Thus, in the example loading plot 500, metadata variables associated with Actor_{—}1 and Actor_{—}2 likely have some relationship to each other, as do variables associated with Subject_matter_{—}1, Subject_matter_{—}2, and Text. These relationships provide helpful information for the generation of rules linking metadata to output states.

Still referring to FIG. 5, as is understood, variables that are grouped together are correlated such that when the value of one variable increases or decreases, the numerical value of the other variable or variables in the group has a tendency to change in the same way. Alternatively, when variables are negatively (i.e. inversely) correlated, they are positioned on opposite sides of the origin and in diagonally-opposing quadrants. For instance, Object_{—}4 515 and Actor_{—}4 505 are inversely correlated, meaning that when a given output state increases when occurrences of Actor_{—}4 increase within a video or videos, that same output state will similarly increase if occurrences of Object_{—}4 decrease. Further, as will be understood by one of ordinary skill in the art, the distances of the variables from the origin and each other, the relative positioning of the variables, and other similar measures, all contribute to the relationships amongst the plotted variables and the output state(s), thus providing information that contributes to the creation of rules.

In the advertising or marketing context, viewer interaction with an advertisement can be an important output state. For example, if the output 400 and/or corresponding loading plot 500 identify a high correlation between certain metadata and viewer interaction with an advertisement, then this information can be used to incorporate that advertisement (or similar types of advertisements) into videos with content matching that metadata. Even videos with no previous viewing metric data may be effectively utilized to display the advertisement, assuming those videos contain the correlated metadata.

Often, identified trends between video content and viewer behavior will be consistent amongst various “classes” of videos (i.e. amongst a particular television series, or a specific movie genre, etc.). As an example, data points associated with different classes are represented by varying types of shapes (e.g. triangles, squares, diamonds, stars, etc.) in the output 400 shown in FIG. 4. This inter-class relation leads to valuable understandings about some or all of the videos in a class, as only a small number of videos within a class will require analyzation to create a set of correlation rules for all videos within the class. For example, if a trend is discovered between a particular character in a television series and a particular output state, then a rule can be created for that trend that can he easily applied to all videos in that television series. As will be understood, however, many trends and correlations will apply across various classes and genres.

As will also be understood, the trends and correlations between metadata and viewer behavior can be used for a variety of purposes, including advertising, editing or creating video content, and other similar uses. Generally, if trends are tightly coupled to metadata, then a rule can be created linking the trend to the content associated with the metadata, such that viewer behavior can be predicted. If a trend in video consumption data is not tightly coupled to any metadata elements, then the video consumption trend may be an aberration, or the cause for the viewer behavior may be irreconcilable with pure metadata alone. Further, over time as trend data is collected and analyzed for many videos and output states, trends of trends may be determined that provide even more detailed analysis linking video attributes to corresponding viewer output states.

The foregoing description of the exemplary embodiments has been presented only for the purposes of illustration and description and is not intended to be exhaustive or to limit the inventions to the precise forms disclosed. Many modifications and variations are possible in light of the above teaching.

The embodiments were chosen and described in order to explain the principles of the inventions and their practical application so as to enable others skilled in the art to utilize the inventions and various embodiments and with various modifications as are suited to the particular use contemplated. Alternative embodiments will become apparent to those skilled in the art to which the present inventions pertain without departing from their spirit and scope.

What is claimed is:

1. A method for predicting viewer behavior toward a new video based on identified patterns in video consumption data associated with a plurality of existing videos, comprising the steps of:
receiving video consumption data comprising one or more output states at particular time points within each of the plurality of existing videos;
receiving time-based metadata associated with the content of the plurality of existing videos;
analyzing the video consumption data and metadata via a multivariate analysis engine to identify patterns associated with the metadata and the one or more output states; and
generating one or more rules to identify likely output states at time points within the new video based on time-based metadata for the new video and based on the identified patterns.

2. The method of claim 1, wherein the step of generating one or more rules to identify likely output states at particular time points within the new video further comprises applying one or more predefined parameters as a filter for identifying the patterns.

3. The method of claim 1, wherein the one or more output states identify viewer behavior and are selected from the group comprising: playing video, pausing video, stopping video, rewinding video, fast-forwarding video, replaying video, recording video, navigating to different video, interacting with an advertisement, and exiting video player.

4. The method of claim 1, wherein the content of the plurality of existing videos with which the time-based metadata is associated is selected from the group comprising: actors, characters, products, objects, places, settings, colors, proper names, subject matter, text, dialogue, audio, genre, descriptions, chapters, and titles.

5. The method of claim 1, further comprising the step of plotting, via the multivariate analysis engine, the video consumption data and metadata on a multidimensional K-space plot.

6. The method of claim 5, further comprising the step of projecting some or all of the plotted video consumption data and metadata onto a two-dimensional plane for subsequent analysis.

7. The method of claim 6, further comprising the step of generating a loading plot based on the projected plotted video consumption data and metadata contained in the two-dimensional plane.

8. A method of identifying trends in video viewing behavior across a plurality of existing videos, comprising the steps of:
receiving video consumption data comprising one or more output states at particular time points within each of the plurality of existing videos, wherein the output states identify specific viewer behavior;
receiving time-based metadata associated with the content of the plurality of existing videos;
analyzing the video consumption data and the time-based metadata via a multivariate analysis engine to identify correlations between the metadata and the one or more output states at the particular time points within each of the plurality of existing videos;
applying one or more predefined parameters as a filter for identifying the correlations between the metadata and the one or more output states; and
identifying one or more of the time-based metadata that is statistically likely to cause a respective output state at a respective particular time point within one or more of the plurality of existing videos.

9. The method of claim 8, wherein the one or more output states are selected from the group comprising: playing video, pausing video, stopping video, rewinding video, fast-forwarding video, replaying video, recording video, navigating to different video, interacting with an advertisement, and exiting video player.

10. The method of claim 8, further comprising the step of plotting, via the multivariate analysis engine, the video consumption data and the time-based metadata on a multidimensional K-space plot.

11. The method of claim 10, further comprising the step of projecting some or all of the plotted video consumption data and the time-based metadata onto a two-dimensional plane for subsequent analysis.

12. The method of claim 11, further comprising the step of generating a loading plot based on the projected plotted video consumption data and metadata contained in the two-dimensional plane.

13. The method of claim 8, further comprising modifying one of the plurality of existing videos based on the identified time-based metadata that is statistically likely to cause the respective output state at the respective particular time point within the one of the plurality of existing videos.

14. The method of claim 13, wherein the step of modifying one of the plurality of existing videos comprises deleting a portion of the video.

15. The method of claim 13, wherein the step of modifying one of the plurality of existing videos comprises inserting additional content into the video.

16. The method of claim 8, further comprising associating an advertisement with one of the plurality of existing videos based on the identified time-based metadata that is statistically likely to cause the respective output state at the respective particular time point within the one of the plurality of existing videos.

17. The method of claim 8, further comprising creating a new video that includes specific content that is deemed statistically likely to cause the respective output state based on the identified one or more of the time-based metadata.

18. The method of claim 8, wherein the time-based metadata is selected from the group comprising: actors, characters, products, objects, places, settings, colors, proper names, subject matter, text, dialogue, audio, genre, descriptions, chapters, and titles
